(19) United States
(12) Patent Application Publication
(10) Pub. No.: US 2009/0187686 A1
(43) Pub. Date: Jul. 23, 2009

(54) Methods and Appartus for Keyboard Video Mouse (KVM) Switching

(75) Inventors: Joe Edgar Goodart, Austin, TX (US); Shuguang Wu, Round Rock, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: DELL PRODUCTS L.P., Round Rock, TX (US)

(21) Appl. No.: 12/017,307

(22) Filed: Jan. 21, 2008

(51) Int. Cl. G06F 13/12

(52) U.S. Cl. 710/72

(57) ABSTRACT

A method for providing communication between a plurality of input/output (I/O) devices and a plurality of information handling systems (IHSs). The method includes providing a first port coupled to the plurality of I/O devices and providing a first channel of the first port for video data. The method also includes providing a second channel of the first port utilized for I/O data and providing a second port coupled to a first IHS of the plurality of IHSs, wherein the first IHS provides video data via the first channel, and the first IHS transmits and receives the I/O data via the second channel.

### BACKGROUND

1. Technical Field

The present disclosure relates generally to the field of information handling systems. More specifically, but without limitation, the present disclosure relates to keyboard video mouse (KVM) switches.

2. Background Information

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for such systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A keyboard video mouse (KVM) console may allow a plurality of input/output (I/O) devices to be coupled to one or more IHSs. A KVM console may also allow a plurality of IHSs to be controlled by a single set of I/O devices. A KVM console may require several cables for connection to I/O devices and several more cables for connection to one or more IHSs. Each cable may handle a different type of signal or may be a different type of cable. For example, a digital visual interface (DVI) cable and a video graphics array (VGA) cable both handle video data, but the cables may have different types of interfaces. Further, video data provided through a VGA cable and a DVI cable may be in different formats.

While a KVM console may eliminate the need for multiple sets of I/O devices, it may still require a substantial number of cables. Further, a KVM console may require complex circuitry because each interface may require circuitry to allow switching between selected IHSs. Both the number of cables and complex circuitry may contribute to keeping the cost of implementing KVM consoles high.

Thus a need remains for methods and apparatus for minimizing the number of cables required to couple a set of I/O devices to a plurality of IHSs.

### SUMMARY

The following presents a general summary of several aspects of the disclosure in order to provide a basic understanding of at least some aspects of the disclosure. This summary is not an extensive overview of the disclosure. It is not intended to identify key or critical elements of the disclosure or to delineate the scope of the claims. The following summary merely presents some concepts of the disclosure in a general form as a prelude to the more detailed description that follows.

One aspect of the disclosure provides a method for providing communication between a plurality of input/output (I/O) devices and a plurality of information handling systems (IHSs). The method includes providing a first port coupled to the plurality of I/O devices and providing a first channel for video data. The method may also include providing a second channel utilized for I/O data and providing a second port coupled to a first IHS of the plurality of IHSs, wherein the first IHS provides video data via the first channel, and the first IHS transmits and receives the I/O data via the second channel.

Another aspect of the disclosure provides an apparatus for providing communication between a plurality of input/output (I/O) devices and a plurality of information handling systems (IHSs). The apparatus includes a first port coupled to the plurality of I/O devices wherein the first port includes a first channel for outputting video data to a display and a second channel utilized for I/O data. The apparatus may further include a second port coupled to a first IHS of the plurality of IHSs, wherein the first IHS provides video data via the first channel, and the first IHS transmits and receives the I/O data via the second channel.

Yet another aspect of the disclosure provides an apparatus for providing communication between a plurality of input/output (I/O) devices and a plurality of information handling systems (IHSs). The apparatus includes a first port coupled to the plurality of I/O devices wherein the first port includes a first channel for outputting video data to a display and a second channel utilized for I/O data. The apparatus may further include a plurality of IHS ports each coupled to one of the plurality of IHSs and a selector, wherein the selector couples the first port to one or more of the plurality of IHS ports.

### BRIEF DESCRIPTION OF THE DRAWINGS

For detailed understanding of the present disclosure, references should be made to the following detailed description of the several aspects, taken in conjunction with the accompanying drawings, in which like elements have been given like numerals and wherein:

FIG. 1 shows a schematic of an information handling system according to the present disclosure;

FIG. 2 represents an illustrative implementation of a keyboard video mouse (KVM) console;

FIG. 3 provides an illustrative implementation of a KVM console circuitry;

FIG. 4 provides a general overview of a DisplayPort link utilizing a DisplayPort standard;

FIG. 5 represents an illustrative implementation of a DisplayPort KVM; and

FIG. 6 provides an illustrative implementation of a DisplayPort KVM circuitry.

### DETAILED DESCRIPTION

Although the invention as been described with reference to specific implementations, it will be understood by those skilled in the art that various changes may be made without departing from the spirit or scope of the invention. Various examples of such changes have been given in the forgoing description. Accordingly, the disclosure of implementations of the disclosure is intended to be illustrative of the scope of the invention and is not intended to be limiting. It is intended that the scope of the invention shall be limited only to the extent required by the appended claims. For example, to one of ordinary skill in the art, it will be readily apparent that the information handling system discussed herein may be implemented in a variety of implementations, and that the forgoing discussion of certain of these implementations does not necessarily represent a complete description of all possible implementations.

For simplicity and clarity of illustration, the drawing and/or figures illustrate the general manner of construction, and descriptions and details of well known features and techniques may be omitted to avoid unnecessarily obscuring the disclosure.

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

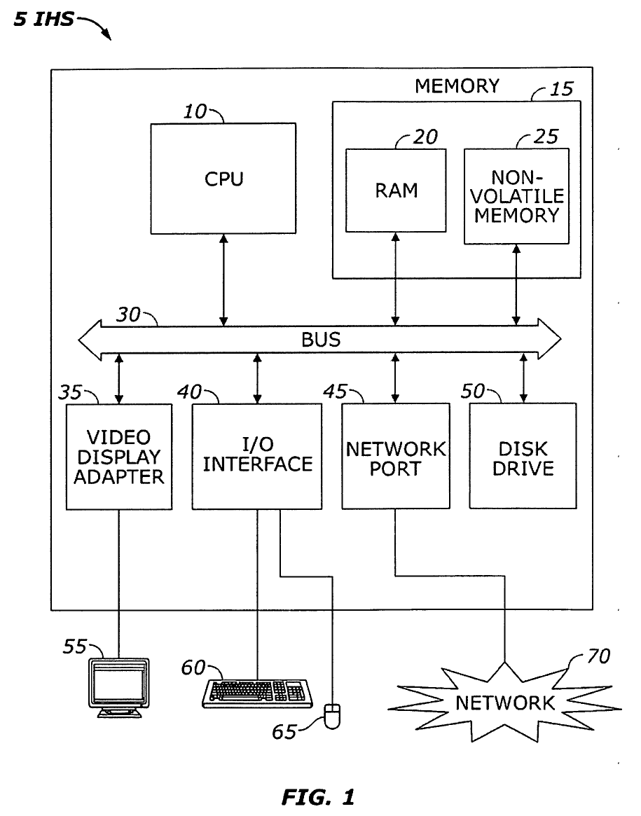

FIG. 1 illustrates one possible implementation of an IHS 5 comprising a CPU 10. It should be understood that the present disclosure has applicability to information handling systems as broadly described above, and is not intended to be limited to the IHS 5 as specifically described. The CPU 10 may comprise a processor, a microprocessor, minicomputer, or any other suitable device, including combinations and/or a plurality thereof, for executing programmed instructions. The CPU 10 may be in data communication over a local interface bus 30 with components including memory 15 and input/output interfaces 40. The memory 15, as illustrated, may include non-volatile memory 25. The non-volatile memory 25 may include, but is not limited to, firmware flash memory and electrically erasable programmable read-only memory (EEPROM). The firmware program (not shown) may contain, programming and/or executable instructions required to control a keyboard 60, mouse 65, video display 55 and/or other input/output devices not shown here. The memory may also comprise RAM 20. The operating system and application programs may be loaded into the RAM 20 for execution.

The IHS 5 may be implemented with a network port 45 to permit communication over a network 70 such as a local area network (LAN) or a wide area network (WAN), such as the Internet. As understood by those skilled in the art, IHS 5 implementations may also include an assortment of ports and interfaces for different peripherals and components, such as video display adapters 35, disk drives port 50, and input/output interfaces 40 (e.g., keyboard 60, mouse 65).

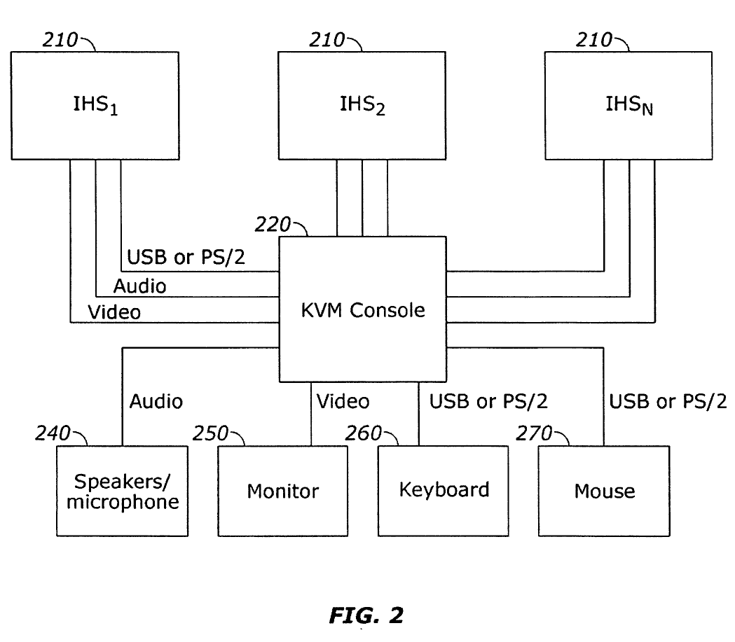

FIG. 2 represents an illustrative implementation of a keyboard video mouse (KVM) console. A KVM console 220 may be utilized to couple several IHSs 210 to several I/O devices. As used in the present disclosure, a KVM console 220 may also be referred to as a KVM switch or the like. As discussed previously, an IHS 210 may have a variety of implementations such as a workstation, a personal computer, a laptop, or the like. Each IHS 210 may be coupled to a KVM console 220 by cables such as a universal serial bus (USB), a Personal System/2 (PS/2) cable, audio cables, a digital visual interface (DVI), video graphics array (VGA) cable, and/or any other suitable cable types. A KVM console 220 may also be coupled to a plurality of I/O devices such as speakers and/or a microphone 240, a monitor or display 250, a keyboard 260, and a mouse 270. An I/O device is a device that may communicate with an IHS via a port or connector. For example, an I/O device may be a speaker(s)/microphone, display, keyboard, mouse, drive, or the like. Further, a type of I/O device may be implemented in a variety of manners. For instance, a display may allow video data to be shown using various technologies such as cathode ray tube (CRT), liquid crystal display (LCD), plasma display, or the like. While in some cases I/O devices may be external or separate from an IHS, I/O devices are not required to be external to the IHS. Further, in the implementation provided, cables such as USB or PS/2 cables, audio cables, and video cables are shown. However, it is well known to one of ordinary skill in the art that the number of cables and the type of cable may vary in accordance with the particular I/O devices present. For example, monitor may use a digital visual interface (DVI) cable or a VGA cable. Further, the number of audio cables required may vary with the number of channels present and the type of cable used.

A KVM console 220 may allow a single set of I/O devices, such as speakers 240, a monitor 250, a keyboard 260, and a mouse 270, to be used for several IHSs 210_{1-N}. In some cases, a KVM console 220 may be used with IHSs that do not require a dedicated keyboard, monitor, and mouse. By allowing a set of I/O devices to communicate with one or more IHS, multiple sets of I/O devices may no longer be needed. A KVM console 220 may couple the I/O devices to an IHS by utilizing a mechanical switch, an electrical switch, a multiplexer, or any other suitable device. In other implementations, a KVM console 220 may couple the I/O devices to more than one IHS. Additionally, a KVM console 220 may be coupled or “daisy chained” to another KVM console to allow even more IHSs to be coupled to I/O devices.

In order to couple I/O devices to several IHSs 210 with a KVM console 220, several cables may be needed. For example, in the implementation shown in FIG. 2, seventeen cables are needed. It is understood that any applicable number cables may be present. The number of cables required can be calculated using the formula:

Number of cables=X*N+(M+Y)

In the formula, N may represent the number of IHSs to be coupled to a KVM console, M may represent the number of I/O devices, and X and Y may represent constants. Constant X may represent the number of cables needed between a KVM console 220 and an IHS 210. Constant Y may represent the number of additional or extra cables needed between I/O devices and a KVM console 220 (in the case where more than one cable is needed). For example, in the particular implementation shown in FIG. 2, the value of X is 4 (i.e., 1 USB cable+2 audio cables+1 video cable) and the value of Y is 1 (i.e., 1 additional audio cable). In alternative implementations, variations in the I/O devices present may require modification to the formula. For example, if the speakers provide for multichannel operation and require 5 cables for audio, then constant X may be 7. Between a KVM console 220 and an IHS 210 there may be one cable for USB, one cable for video, and five cables for audio. Further, constant Y would be four because four extra cables would be needed for the audio.

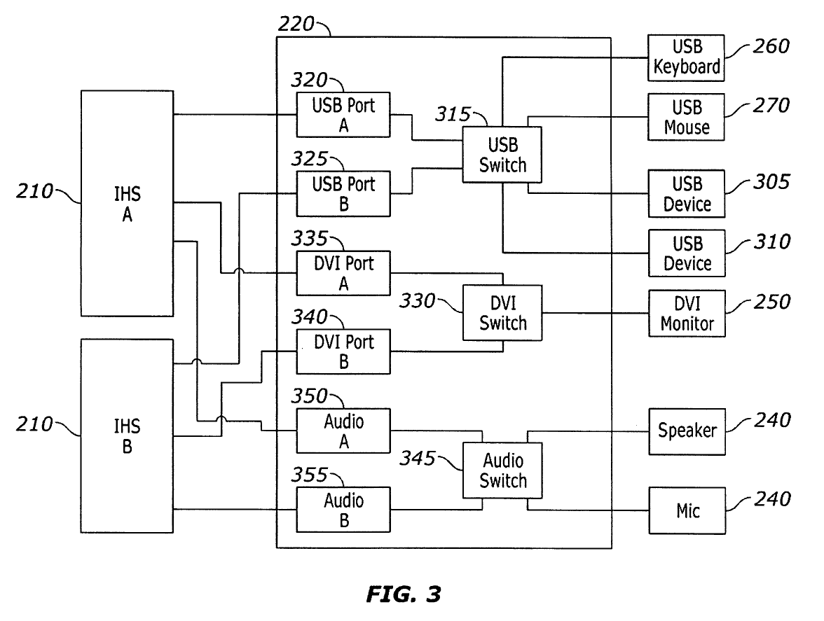

FIG. 3 provides an illustrative implementation of a KVM console circuitry. As discussed previously, I/O devices may utilize a variety of different types of cables and connectors. The present disclosure is in no way limited to the particular type of cables and connectors described herein. Various combinations of cable types and connectors may be implemented in a KVM console. A KVM console 220 may provided ports for a USB keyboard 260, a USB mouse 270, a first 310 and second USB device 315, a DVI monitor 250, a microphone 240, speakers 240, as well as additional I/O devices. A USB switch 315 may receive or transmit signals to/from several USB devices. A USB switch 315 may essentially allow several USB devices to be changed from being coupled to a first IHS to being coupled to another IHS. A USB switch 315 may select one of the IHSs to be coupled to the USB devices utilizing USB port A 320 or USB port B 325. It is understood to one of ordinary skill in the art that a port may also be referred to as a connector or the like. A USB switch 315 may be switch back-and-forth between coupling the USB devices to USB port A 320 and USB port B 325 or vice versa. The USB switch 315 may thus obviate the need for multiple sets of USB devices to control several IHSs. It is understood by one of ordinary skill in the art that any suitable alternative may be utilized in place of a switch. For example, a relay, a multiplexer, or any other suitable alternative may be used in place of any of the switches discussed herein.

An IHS A 210 may be coupled to a DVI port A 335 that provides a signal to a DVI switch 330, and an IHS B 210 may be coupled to a DVI port B 340 that also provides a signal to a DVI switch 330. A DVI switch 330 may select a signal from a particular IHS coupled to one of the DVI ports to be displayed on a DVI monitor 250. For example, when the DVI monitor 250 is coupled to the IHS A 210, the DVI monitor 250 may display a signal from the IHS A 210. However, when the DVI switch 330 couples the DVI monitor 250 to the IHS B 210, the DVI monitor 250 may display a signal from the IHS B 210.

An IHS A 210 may be coupled to an audio A port 350, and an IHS B 210 may be coupled to an audio port B 355. Audio port A 350 and audio port B 355 may be coupled to an audio switch 345. An audio switch 345 may provide an audio signal from IHS A 210 or IHS B 210 to speakers 240. Additionally, a microphone 240 may provide an audio signal to audio port A 350 or audio port B 355. An audio switch 345 may allow one to select between coupling audio inputs and outputs to a first IHS or a second IHS. In one implementation, the USB switch 315, DVI switch 330, and audio switch 345 operate uniformly to couple all of the I/O devices to one of the IHSs 210. For example, when a USB keyboard 260 and a USB mouse are couple to IHS A 210, a DVI monitor 250, speakers 240, and microphone 240 may also be coupled to IHS A 210. In the illustrative implementation shown in FIG. 3, two USB ports, two DVI ports, and two audio ports are provide. However, any number of additional ports may be provided to accommodate additional IHSs. While a KVM console 220 may save cost by reducing I/O devices, these costs may be offset by the costs of the KVM console and the additional cables required.

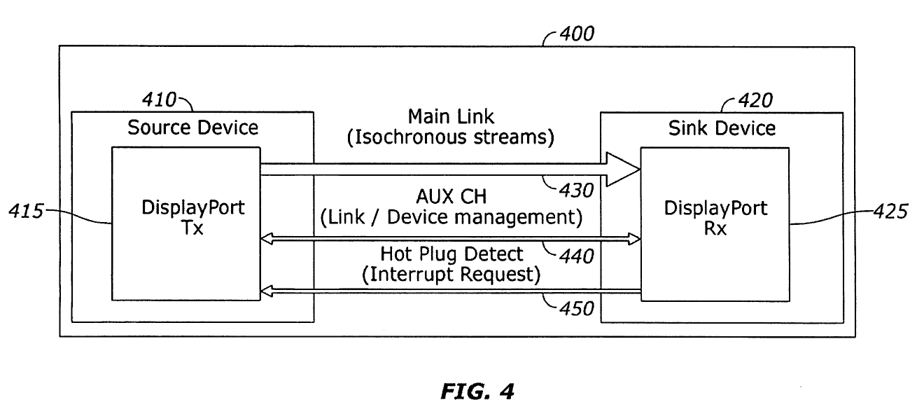

The Video Electronics Standards Association (VESA) has proposed the use of a new DisplayPort standard. DisplayPort is a digital display interface standard that reduces device complexity and provides performance scalability. FIG. 4 provides a general overview of a DisplayPort link utilizing a DisplayPort standard. The DisplayPort Standard Version 1.1 is herein incorporated by reference. In a DisplayPort link 400, there may be a source device 410 that may send data to a sink device 420. A source device 410, such as an IHS, DVD player, or the like, may provide data. A sink device 420, such as a monitor, TV, or the like, may receive data. The source 410 and sink devices 420 may be coupled via a main link 430, an auxiliary channel (AUX CH) 440, and/or a hot-plug detect (HPD) signal line 450. A transmitter (Tx) 415 in the source device may send isochronous data streams through the main link 430 to a receiver (Rx) 425. The data streams may contain video data, audio data, control or management data, and the like. Video data may contain data representing moving images and/or still images. Audio data may contain data representing sounds or the like. The main link 430 may be a uni-directional, high-bandwidth and low-latency channel which may be primarily used for audio and video data. The AUX CH 440 may be a half-duplexed bidirectional channel that may be used to send link management and device control data. The HPD signal line 450 may allow the source device 410 to detect a coupling to a sink device 420. The HPD also may allow an Rx 425 in the sink device to send an interrupt request (IRQ) to the source device.

While DisplayPort version 1.1 defines an auxiliary channel speed of 1 MHz, it is anticipated that subsequent versions of DisplayPort may increase the auxiliary channel to speeds of more than 500 MHz. This increase in the speed of a DisplayPort auxiliary channel could allow input/output (I/O) data from a plurality of I/O devices to be sent via a DisplayPort link. For example, USB 1.1 may support a data rate of 12 Mbps and USB 2.0 may support a data rate of 480 Mbps. Increasing a DisplayPort auxiliary channel speed to 500 MHz or more may allow both USB 1.1 and USB 2.0 to be supported via a DisplayPort auxiliary channel.

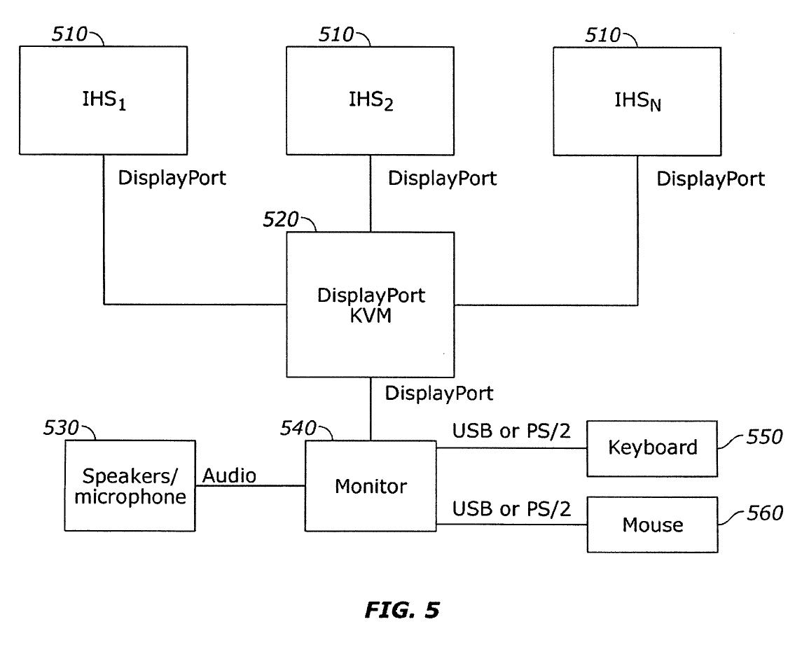

FIG. 5 represents an illustrative implementation of a DisplayPort KVM. Several IHSs 510_{1-N} may be coupled to a DisplayPort KVM 520. A DisplayPort KVM 520 may be a type of KVM console that utilizes DisplayPort links to provide KVM console functionality. A DisplayPort KVM 520 may be coupled to a monitor 540 by a DisplayPort link. Further, a monitor 540 may be coupled to speakers and/or a microphone 530 by audio cables, a keyboard 550 and/or a mouse 560 by USB or PS/2 cables, and the like. Signals from a microphone 530, a keyboard 550, mouse 560, and any other I/O devices coupled to a monitor 540 may be sent through a DisplayPort auxiliary channel (not expressly shown) to a DisplayPort KVM 520. In turn, DisplayPort KVM 520 may provide the signals to one or more IHSs 510^{1-N} via an auxiliary channel between the DisplayPort KVM 520 and the IHS(s) 510^{1-N}. Audio/video (A/V) signals from one or more of the IHSs 510^{1-N} may be provided through a main link (not expressly shown) to a DisplayPort KVM 520. A/V signals may then be provided to a monitor 540 via a main link and the monitor 540 may process the video data and provide the audio signal to speakers 530. In another implementation, audio data may be received and transmitted through an auxiliary channel of a DisplayPort link if an increase in an auxiliary channel speed provides enough bandwidth (i.e., both a microphone and speakers would utilized an auxiliary channel). As used in the present disclosure, I/O data may refer to data transmitted or received to/from an I/O device via an auxiliary channel of a DisplayPort link.

By utilizing an auxiliary channel of a DisplayPort link, the number of cables required to couple several I/O devices to several IHSs can be significantly reduced. For the implementation shown in FIG. 5, the number of cables required can be calculated using the formula:

Number of cables=N+(M+Y)

In the formula above, as in the previous formula, N represents the number of IHSs that will be coupled to a DisplayPort KVM, M represents the number of I/O devices to be coupled to the DisplayPort KVM, and Y is a constant representing the number of additional or extra cables I/O devices require to couple to a monitor 540. In the implementation shown N=3, M=4, and Y=1. The number of cables required may be reduced from seventeen cables in the implementation shown in FIG. 2 to eight, which is a reduction of more than 50%. However, it should be noted that the reduction is dependent on the number of IHSs and I/O devices. The formula above, similar to the previous formula, may need to be modified if different I/O devices are used (i.e., I/O devices requiring a different number of cables).

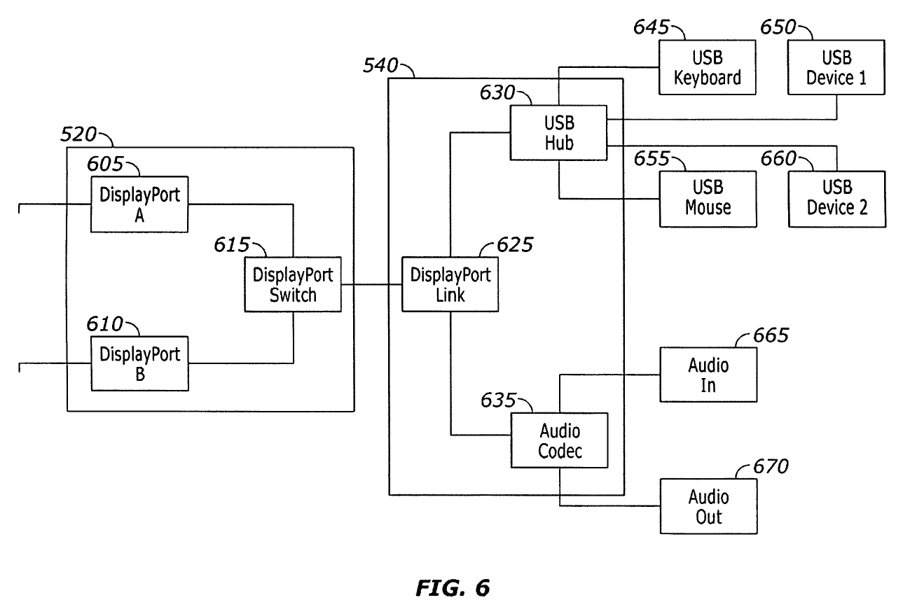

FIG. 6 provides an illustrative implementation of a DisplayPort KVM circuitry. In addition to reducing the number of cables required, a DisplayPort KVM could also provide a more simplified circuitry. A first IHS and a second IHS may be coupled to a DisplayPort KVM 520 via DisplayPort A 605 and DisplayPort B 610. DisplayPort A 605 and DisplayPort B 610 may be coupled to a DisplayPort switch 615 which selects one or more IHSs that are to be in communication with I/O devices. A DisplayPort KVM may also be coupled to a monitor 540 via a DisplayPort link 625. A DisplayPort link in a monitor 540 may be coupled to a USB hub 630 and an audio coder/decoder (codec) 635. A USB hub 630 may be coupled to a plurality of USB devices such as a USB keyboard 645, a first USB device 650, a USB mouse 655, and a second USB device 660. An audio codec 635 may be coupled to an audio in 665 (e.g., microphone) and an audio out (e.g., speakers) 670. A user or the like may change from coupling several I/O devices to a first IHS to coupling the I/O devices to a second IHS quickly and easily by utilizing a DisplayPort KVM 520.

As discussed previously, a DisplayPort KVM 520 may allow I/O devices to transmit and/or receive data to/from one or more IHSs (depending on the device). In addition to reducing the number of cables and simplifying KVM circuitry, KVM architecture may be simplified as well. Because DisplayPort may provide a packet data layered structure, switching of different types of data (e.g., video, USB, and audio) may be simplified. In another implementation of a DisplayPort KVM, a monitor may not offer USB and audio support. In such an implementation, audio switching and decoding as well as USB switching may then be provided in a DisplayPort KVM. For example, a DisplayPort KVM may provided I/O ports for audio devices and USB devices instead of receiving and transmitting audio and USB data from a DisplayPort link.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, and/or use of equivalent functional junctions for couplings/links described herein.

What is claimed is:

1. A method for providing communication between a plurality of input/output (I/O) devices and a plurality of information handling systems (IHSs), the method comprising:
providing a first port coupled to the plurality of I/O devices;
providing a first channel of the first port for video data;
providing a second channel of the first port utilized for I/O data; and
providing a second port coupled to a first IHS of the plurality of IHSs, wherein the first IHS provides video data via the first channel, and the first IHS transmits and receives the I/O data via the second channel.

2. The method of claim 1, wherein the first port is coupled to the plurality of I/O devices via a display.

3. The method of claim 1, wherein the first port and second port are DisplayPorts.

4. The method of claim 1, wherein the first channel may further be utilized for audio data.

5. The method of claim 2, wherein the plurality of I/O devices are selected from a group consisting of a keyboard, a mouse, speakers and a microphone.

6. The method of claim 3 further comprising:
providing a third port coupled to a second one of the plurality of IHSs, wherein the third port is a DisplayPort, and the first channel and the second channel are switched to allow the second IHS to provide video data via the first channel and to transmit and receive the I/O data via the second channel.

7. The method of claim 1, wherein a number of cables needed to couple the plurality of I/O devices to the plurality of IHSs is equal to N+(M+Y), wherein N equals the number of IHSs, M equals the number of I/O devices, and Y is a constant representing the number of additional cables required by the I/O devices.

8. An apparatus for providing communication between a plurality of input/output (I/O) devices and a plurality of information handling systems (IHSs), the apparatus comprising:
a first port coupled to the plurality of I/O devices, wherein the first port comprises:
a first channel for outputting video data to a display; and
a second channel utilized for I/O data; and
a second port coupled to a first IHS of the plurality of IHSs, wherein the first IHS provides video data via the first channel, and the first IHS transmits and receives the I/O data via the second channel.

9. The apparatus of claim 8, wherein the first port is coupled to the plurality of I/O devices via a display.

10. The apparatus of claim 8, wherein the first port and second port are DisplayPorts.

11. The apparatus of claim 8, wherein the first channel may further be utilized for audio data.

12. The apparatus of claim 9, wherein the plurality of I/O devices are selected from a group consisting of a keyboard, a mouse, and speakers.

13. The apparatus of claim 10 further comprising:
a third port coupled to a second IHS of the plurality of IHSs, wherein the third port is a DisplayPort, and the first channel and the second channel are switched to allow the second IHS to provide video data via the first channel and to transmit and receive the I/O data via the second channel.

14. The apparatus of claim 8, wherein a number of cables needed to couple the plurality of I/O devices to the plurality of IHSs is equal to N+(M+Y), wherein N equals the number of IHSs, M equals the number of I/O devices, and Y is a constant representing the number of additional cables required by the I/O devices.

15. An apparatus for providing communication between a plurality of input/output (I/O) devices and a plurality of information handling systems (IHSs), the apparatus comprising:
a first port coupled to the plurality of I/O devices, wherein the first port comprises:
a first channel for outputting video data to a display; and
a second channel utilized for I/O data;
a plurality of IHS ports each coupled to one of the plurality of IHSs; and
a selector, wherein the selector couples the first port to one or more of the plurality of IHS ports.

16. The apparatus of claim 15, wherein the first port is coupled to the plurality of I/O devices via a display.

17. The apparatus of claim 15, wherein the first port and the plurality of IHS ports are DisplayPorts.

18. The apparatus of claim 15, wherein the one or more of the IHSs further utilizes the first channel to provide audio data.

19. The apparatus of claim 16, wherein the plurality of I/O devices are selected from a group consisting of a keyboard, a mouse, and speakers.

20. The apparatus of claim 15, wherein a number of cables needed to couple the plurality of I/O devices to the plurality of IHSs is equal to N+(M+Y), wherein N equals the number of IHSs, M equals the number of I/O devices, and Y is a constant representing the number of additional cables required by the I/O devices.
